(19) United States
(12) Patent Application Publication
(10) Pub. No.: US 2015/0211729 A1
(43) Pub. Date: Jul. 30, 2015

(54) BOTTLE LIGHTING DEVICE AND METHOD

(71) Applicants: John A. Mahlmeister, Mountain View, CA (US); Lucy Mahlmeister, Mountain View, CA (US); Drew Mahlmeister, Mountain View, CA (US); Zoe Mahlmeister, Mountain View, CA (US)

(72) Inventors: John A. Mahlmeister, Mountain View, CA (US); Lucy Mahlmeister, Mountain View, CA (US); Drew Mahlmeister, Mountain View, CA (US); Zoe Mahlmeister, Mountain View, CA (US)

(21) Appl. No.: 14/610,761

(22) Filed: Jan. 30, 2015

Related U.S. Application Data
(60) Provisional application No. 61/933,328, filed on Jan. 30, 2014.

(51) Int. Cl. F21V 33/00; A47G 19/22; F21V 23/04; B65D 1/02

(52) U.S. Cl. CPC F21V 33/0036; B65D 1/0223; A47G 19/2227; F21V 23/0414; A47G 2019/2238; F21Y 2101/02

(57) ABSTRACT

A device and method for lighting a bottle includes a power module having a housing containing a battery. The housing is dimensioned to be inserted through the bottle opening and into the interior of the bottle. A bottle stop is attached to the housing and engages the lip of the bottle when the housing is positioned within the interior of the bottle. The power module also includes a switch that communicates with the battery and a light strand connected to the power module. The light strand includes a lamp connected to a power conductor. The light strand is positioned within the interior of the bottle and the lamp is illuminated by the battery when the switch is activated.

### CLAIM OF PRIORITY

This application claims priority to U.S. Provisional Patent Application No. 61/933,328, filed Jan. 30, 2014, the contents of which are hereby incorporated by reference.

### FIELD OF THE INVENTION

The present invention relates generally to decorative lighting and, in particular, to a device and method for lighting bottles.

### BACKGROUND

Beverages, such as liquor, wine, beer, soda, water and juices, may often be purchased in transparent, decorative bottles. For example, the bottles may be made out of colored glass, have a decorative shape or surface pattern and/or feature printed or painted artwork or labels. As a result, such bottles are often displayed, such as on a bar or shelf, for decorative purposes. Illuminating such a bottle often enhances the display. In addition, in view of the increasing popularity of “green” practices and products, recycling a bottle, after the beverage contents are consumed, into a decorative piece is appealing to many consumers.

Devices for lighting the interiors of bottles or other beverage containers have been developed. Examples of such devices appear in U.S. Patent Application Publication Nos. US 2004/0114353 to Jensen and US 2010/0157579 to Kononuk. The devices of these published applications feature bases or coasters that a bottle sits on. Lights are positioned within the bases and shine up into the interiors of bottles placed thereon. While such a device works well for bottles filled with liquid, they suffer from disadvantages. More specifically, the devices themselves are not particularly attractive and, since they support the bottles, they are clearly visible and thus detract from the appearance of the bottle. Furthermore, the devices have a larger footprint than do bottles themselves, and thus they consume valuable shelf or bar space when used.

Plug-in strands of lights, of the type typically used for holiday decorations, may be inserted into an empty bottle to light the interior of the bottle, but such light strands require an external power source, such as a wall-mounted electrical receptacle, to provide power to the strand. This results in an unattractive power cord running down the side of the bottle and multiple power cords if multiple bottles are provided with their own light strands. Alternatively, an opening for the power cord may be formed near the bottom of the bottle, but such an approach requires that the bottle be altered in a time-consuming and potentially difficult (and hazardous) operation. In addition, a bottle containing a plug-in strand of lights must be positioned near an electrical outlet, which limits placement options for the illuminated bottle.

Battery-powered strands of lights are known, but they typically feature battery packs that are too large to be inserted into a bottle. As a result, the battery pack must sit next to the bottle or somehow be secured to the exterior of the bottle, both of which significantly detract from the appearance of the bottle. In instances where the battery pack is small enough to fit through the opening of the bottle, the battery pack will fall to the bottom of the bottle and be difficult to retrieve.

A need therefore exists for a device and method for illuminating an interior of a bottle that addresses at least some of the above issues.

### BRIEF DESCRIPTION OF THE DRAWINGS

FIG. 1 is an exploded perspective view of a power module and a compatible light strand in an embodiment of the present invention;

FIG. 2 is a schematic diagram of a circuit of the power module of FIG. 1;

FIG. 3 is an assembled perspective view of the power module of FIG. 1;

FIG. 4 is a perspective view of the light strand of FIG. 1 attached to the power module of FIG. 3;

FIG. 5 is a perspective view of the power module of FIG. 3 positioned within a beverage bottle;

FIG. 6 is an enlarged partial side elevational view of the top portions of the beverage bottle and power module of FIG. 5;

FIG. 7 is a perspective view of the power module and light strand of FIG. 4 positioned within a beverage bottle.

### DETAILED DESCRIPTION OF EMBODIMENTS

While the invention is described below in terms of use with a beverage bottle, it is to be understood that it may be used to illuminate the interior of any type of bottle or container.

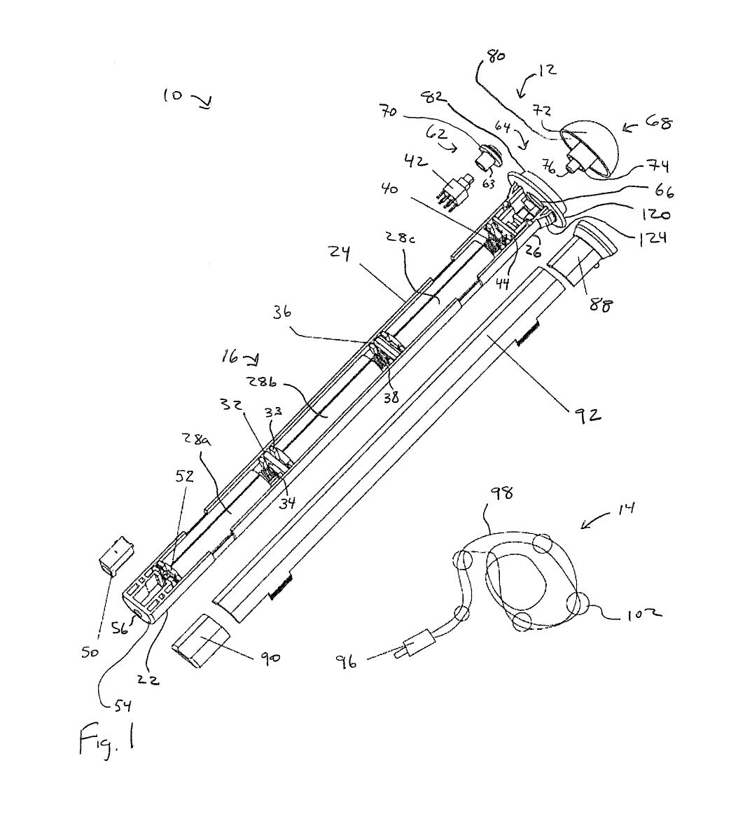

An embodiment of the bottle lighting device of the present invention is indicated in general at 10 in FIG. 1. The device includes two primary components: a power module, indicated in general at 12, and a lighting element, indicated in general at 14. The power module 12 includes a generally cylindrical, elongated housing, indicated in general at 16. The housing features a distal tip portion 22, a middle portion 24 and a proximal end portion 26. The housing preferably is constructed from plastic.

The middle portion of the housing 24 defines a battery compartment configured to receive three AAA batteries 28a, 28b and 28c in a removable fashion. A contact plate 32 is secured within the battery compartment of the housing by tabs 33 with a contact spring 34 attached thereto. The contact spring 34 engages the negative terminal of battery 28a and the contact plate engages the positive terminal of battery 28b. Contact plate 36 similarly engages the positive terminal of battery 28c while contact spring 38 (which is attached to contact plate 36) engages the negative terminal of battery 28b. A contact spring 40 engages the negative terminal of battery 28c. It is also possible to arrange the batteries in the housing without the use of multiple contact springs, thus connecting the positive terminal of one battery directly to another utilizing only a single spring at the bottom or perhaps no spring at all.

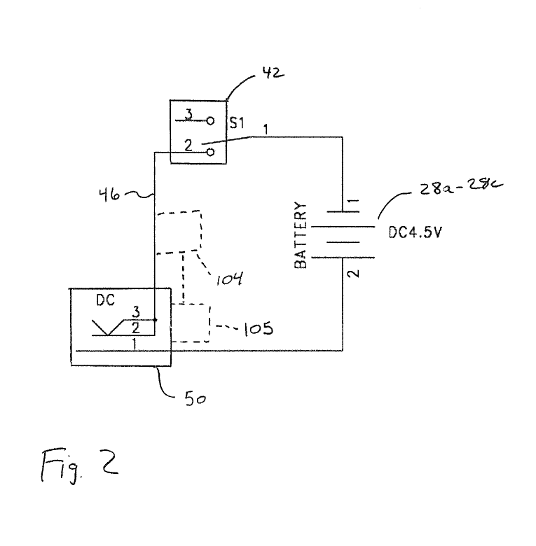

The proximal end portion 26 of the housing defines a switch compartment within which a push switch 42 is positioned. The push switch connects to battery contact spring 40 and a proximal contact 44 that is connected to a conductive strip or wire (46 in FIG. 2) that runs under the batteries 28a-28c of FIG. 1 to a jack 50. The distal tip portion 22 of the housing defines a jack compartment that houses the jack 50. A contact plate 52 is engaged by the positive terminal of battery 28a and is also connected to the jack 50. The distal tip of the housing features a distal tip end wall 54 featuring an opening 56 through which the jack opening may be accessed by a plug. Of course the jack position within the housing, and the location of the corresponding opening 56 in the housing, may be varied.

As shown in FIG. 1, a switch cap, indicated in general at 62, features a hollow cylindrical portion 63 that is positioned upon or connected to the push switch 42 so that the switch 42 is actuated when the switch cap is moved towards the switch and released. The switch cap 62 is also positioned within the switch compartment in the proximal end portion of the housing.

The proximal end portion of the housing is provided with a push button guide, indicated in general at 64, having a central opening 66. The push button guide may be manufactured as a separate piece and secured to the proximal end of the housing by an adhesive, fastener or a press-fit arrangement, or it may be integrally molded with the housing.

With reference to FIG. 1, a push button, indicated in general at 68, features a dome-shaped push surface 72 and a stem 74. Of course the push surface 72 may be a shape other than a dome. The push button stem 74 passes through the opening 66 of the push button guide 64 and features a reduced diameter rod portion 76 that is received and secured within a corresponding bore formed in the top of switch cap 62. The push switch 42 contains a spring so that the switch cap 62, and thus the push button 68, are urged away from the push switch when the push button is not being pushed. The switch cap 62 is provided with a switch cap stop in the form of an annular flange 70 having a diameter larger than opening 66 to limit travel of the switch cap, and thus push button 68, away from the switch. When the push surface 72 of the push button is pushed by a user, the switch 42 is actuated.

The underside of the dome push surface 72 defines a hollow space 80 that receives an annular wall 82 of the push button guide 64 so as to assist in guiding the push button 68 as it is pushed and released.

While an alternative type of switch may be used, such as a toggle switch, a twist-knob switch, a mercury switch or any other type of switch, the push switch is preferred in that it provides an attractive appearance and permits a user to activate the switch merely by pushing down on the push button 68 using only one hand thus avoiding the necessity of using the other hand to steady the bottle. It is also possible to put the switch inside the housing such that the portion of the device remaining outside of the bottle does not have a switch and therefore the top/flange of the device could be flat.

It is to be understood that the switch cap stop 70 may take a form other than a circumferential flange, including, but not limited to, a tab or any other type of protrusion. In addition, the switch cap stop may also possibly be omitted when alternative switch types are used.

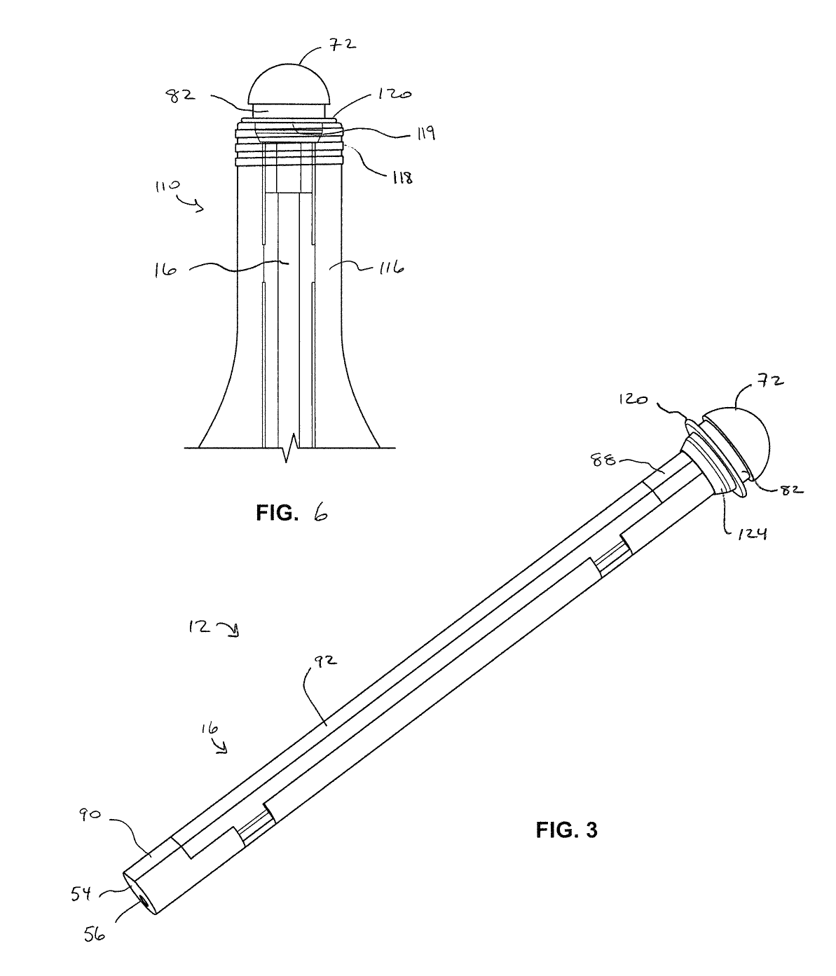

With reference to FIGS. 1 and 3, a switch compartment cover 88 is positioned over the switch compartment and secured to the housing, such as by adhesive, fasteners or a press-fit arrangement. A distal tip portion cover 90 is similarly positioned and secured over the jack compartment. A battery door 92 is secured over the battery compartment in a releasable fashion so that the batteries 28a-28c may be installed or replaced.

It is to be understood that the housing may be a shape other than elongated and generally cylindrical. It should also be understood that an alternative number of batteries and/or battery types may be contained in the housing. Furthermore, instead of a battery compartment door, a removable end cap or other arrangement for accessing the batteries may be used. As a further alternative, the batteries may be rechargeable and not accessible at all. This would also apply for a disposable version of the device.

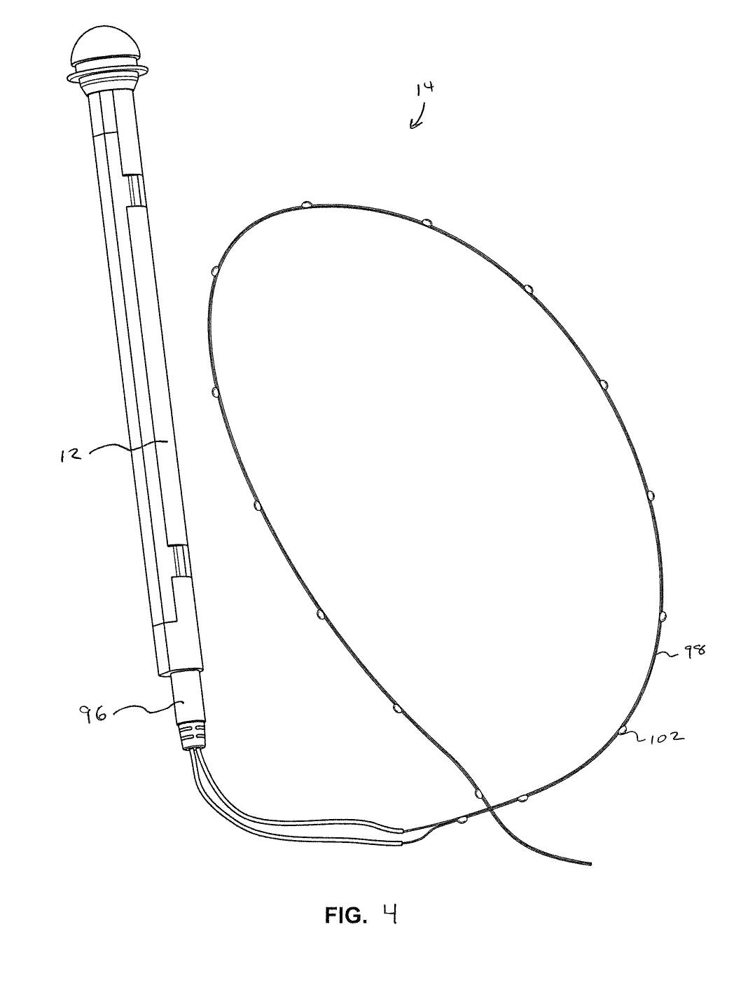

As illustrated in FIGS. 1 and 4, the lighting element 14 may be a light strand that includes a plug 96, which is compatible with the jack 50 of the power module so that the light strand 14 may be plugged into the power module 12. The plug 96 is connected to a power conductor, such as a pair of wires 98, that provide power to lamps 102, which are preferably light emitting diodes. Of course other types of lamps may be used and the light strand may alternatively be hard-wired to the power module 12. Furthermore, while a single strand of lamps is illustrated, multiple lamp strands may alternatively be connected to a single plug. In addition, the lighting element may take a form other than a strand. For example, the lighting element could include lamps mounted directly to, on or within the housing 16 of the power module, so that the lamps are not suspended from the power module by wires.

With reference to the schematic diagram of FIG. 2, which illustrates the circuit of the power module 12 of FIGS. 1 and 3, when switch 42 is turned on, power from the batteries 28a-28c flows to the jack 50. As a result, when the plug of the light strand (96 in FIG. 1) is plugged into the jack 50, power from the batteries is provided to the light strand so that the lamps 102 are illuminated.

As illustrated in FIG. 2, the circuit of the power module may optionally feature additional circuitry, illustrated in phantom at 104, that provides additional functionality when the switch is turned on. Such functionality may include, as examples only, flashing of the lamps 102 (FIG. 1), audio effects or a sensor capable of synchronizing the light effects with music or other audio signals. Furthermore, the power module may be provided with a motor, indicated in phantom at 105 in FIG. 2, that rotates the lighting element 14 with respect to the power module housing 16. The lamps in such an embodiment could be either hard-wired to the housing 16 or be removable (such as illustrated in FIGS. 1 and 2) and could be positioned on the housing or attached thereto via a strand. In addition or alternatively, the additional circuitry 104 could provide for remote control activation of the lamps of the lighting element 14 and/or the motor 105. This remote-control feature could also be incorporated into the switch 42 itself.

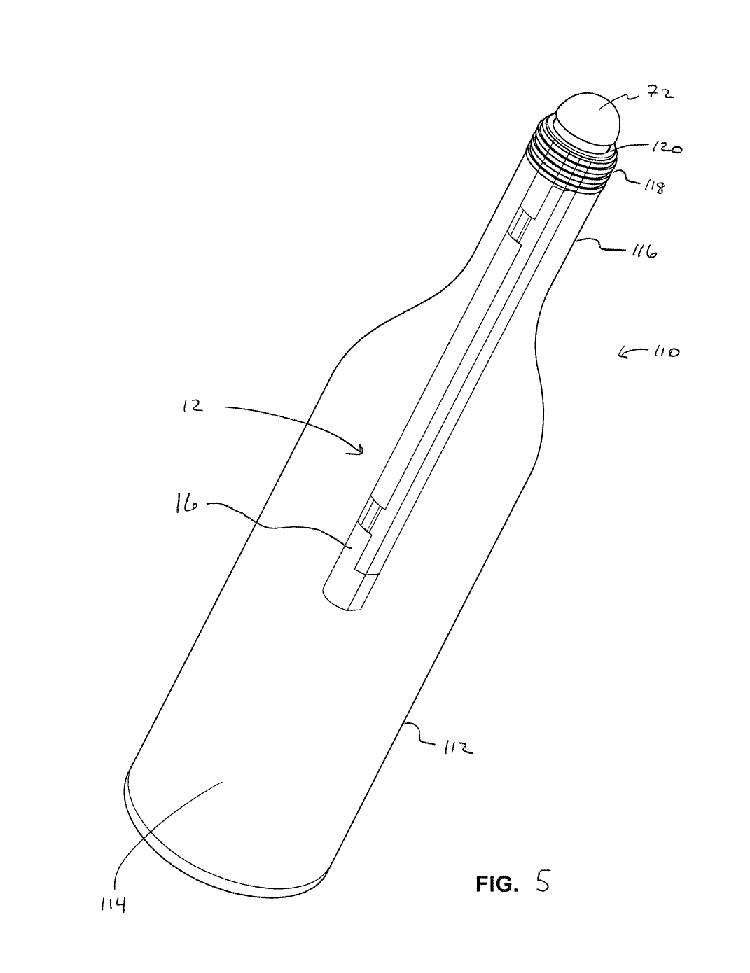

As illustrated in FIG. 5, the housing 16 of the power module 12 is sized to fit into a beverage bottle, indicated in general at 110, with the push button push surface 72 exposed for easy access.

The bottle features a primarily transparent sidewall 112 that defines a bottle interior 114. The top portion of the bottle sidewall defines a neck portion 116 that terminates in an upper lip portion 118 that surrounds and defines an opening 119 of the bottle. The opening of the bottle is in communication with the interior so that the bottle interior may be accessed through the opening. It should be noted that the lip 118 may or may not have the same thickness as the remaining portion of the bottle sidewall. In addition, the bottle may take a shape other than the generally cylindrical one illustrated, and may or may not include the neck portion 116.

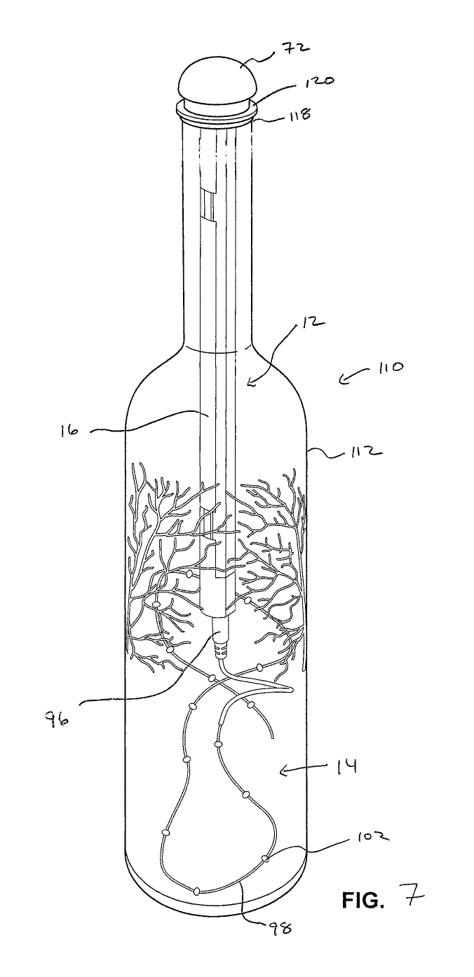

The push button guide (64 of FIG. 1) includes a bottle stop in the form of an annular flange 120. The annular flange 120 has a diameter greater than the diameter of the bottle opening 119 so that when the housing 16 of the power module is inserted through the bottle opening and down into the interior of the bottle, the bottle stop 120 engages the bottle lip 118. As a result, travel of the power module into the bottle interior is stopped, and the push surface 72 of the push button remains exposed for easy operation, as best illustrated in FIGS. 5 and 6.

The top surface of the bottle stop 120 may also optionally limit the downward travel of the push button 68 when it is pushed.

It should be noted that while an annular flange is illustrated, the bottle stop 120 could take the form of any protrusion, such as one or more tabs or a tapered or wedge surface.

As best shown in FIGS. 1 and 3, the proximal end portion of the power module housing may be provided with a tapered collar portion 124. This assists in guiding and centering the power module as it is inserted into the opening 119 of the bottle. As illustrated in FIG. 1, it also provides a fastening channel for the push button guide 64.

The dimensions of the power module 12 and bottle stop 120 of the power module are based on the size and type of bottle that the device is used with. As an example only, for a typical wine bottle, the power module may have a length of 211.5 mm, a housing outer diameter of 14.5 mm and an outer diameter of the bottle stop of 26 mm.

In use, with reference to FIG. 7, the light strand (14 of FIGS. 1 and 4) is placed within the interior of the bottle. This may be accomplished before or after the light strand is connected to the power module (via plug 96 of FIGS. 1 and 4 engaging the power module jack 50 of FIG. 1). Either way, once the light strand is attached to the power module, the power module housing 16 is lowered into the interior of the bottle until the bottle stop 120 engages the lip 118 of the bottle. The push button push surface 72 may then be pressed so that the lamps of the light strand are illuminated, thus illuminating the interior of the bottle, as visible through the transparent sidewall of the bottle 112, to provide a pleasing visual effect.

In view of the above, the described embodiment of the invention allows anyone to produce a decorative bottle that is lit from the inside without using special tools, cutting additional holes or having wires or batty packs exposed. Connection to an external power supply or lighting source is also avoided. The user simply inserts the light strand and housing through the bottle opening and the device is suspended within the bottle interior by the bottle stop of the device.

In addition, by providing a power module with a jack so that the light strand may be removed, the embodiment of the invention described above permits alternative light strands to be used with a single power module. For example, a light strand having multi-color lamps may be substituted for a light strand having white lamps only. As another example, a light strand having multiple strands connected to the plug may replace a light strand with a single strand connected to the plug.

While the preferred embodiments of the invention have been shown and described, it will be apparent to those skilled in the art that changes and modifications may be made therein without departing from the spirit of the invention, the scope of which is defined by the following claims.

What is claimed is:

1. A device for lighting a bottle, where the bottle has a sidewall defining an interior of the bottle and a lip of the sidewall defining an opening that is in communication with the interior of the bottle, said device comprising:
a. a power module including:
i) a housing adapted to contain a battery and be inserted through the bottle opening and into the interior of the bottle;
ii) a bottle stop attached to the housing and adapted to engage the sidewall of the bottle when the housing is positioned within the interior of the bottle;
iii) a switch adapted to communicate with a battery contained in the housing;
b. a lighting element including a lamp connected to a power conductor, said lighting element adapted to be positioned within the interior of the bottle and the power conductor connected to or adapted to be connected to the power module so as to receive power from a battery contained in the power module to illuminate the lamp when the switch is activated.

2. The device of claim 1 wherein the power module further comprises a jack connected to the switch and the lighting element has a light strand that includes a plug connected to the power conductor and adapted to removably engage the jack.

3. The device of claim 2 wherein the housing includes a proximal end portion including a switch compartment housing the switch, a middle portion including a battery compartment adapted to contain a battery and a distal tip portion including a jack compartment housing the jack.

4. The device of claim 3 wherein the bottle stop is attached to the proximal end portion of the housing.

5. The device of claim 4 wherein the switch is a push switch that includes a push surface that extends from the proximal end of the housing and is positioned exterior to the bottle when the housing is positioned within the interior of the bottle with the bottle stop in engagement with the bottle sidewall.

6. The device of claim 1 wherein the lighting element includes a light strand.

7. The device of claim 6 wherein the light strand includes a plurality of lamps in communication with the power conductor.

8. The device of claim 1 wherein the bottle stop is adapted to engage the lip of the bottle when the housing is positioned within the interior of the bottle.

9. The device of claim 1 wherein the switch is adapted to be positioned exterior to the bottle when the housing is positioned within the interior of the bottle.

10. The device of claim 9 wherein the switch is a push switch.

11. The device of claim 1 wherein the lamp of the lighting element is a light emitting diode

12. The device of claim 1 wherein the bottle stop includes an annular flange having a diameter that is greater than a diameter of the bottle opening.

13. A power module for powering a lighting element to light a bottle, where the bottle has a sidewall defining an interior of the bottle and a lip of the sidewall defining an opening that is in communication with the interior of the bottle, said power module comprising:
a. a housing adapted to contain a battery and be inserted through the bottle opening and into the interior of the bottle;
b. a bottle stop attached to the housing and adapted to engage the sidewall of the bottle when the housing is positioned within the interior of the bottle;
c. a switch adapted to communicate with a battery contained in the housing; and
d. circuitry connected to the switch and adapted to connect to the lighting element.

14. The power module of claim 13 wherein the circuitry includes a jack connected to the switch.

15. The power module of claim 13 wherein the bottle stop is adapted to engage the lip of the bottle when the housing is positioned within the interior of the bottle.

16. The power module of claim 15 wherein the bottle stop is attached to a proximal end portion of the housing.

17. The power module of claim 13 wherein the switch is adapted to be positioned exterior to the bottle when the housing is positioned within the interior of the bottle.

18. The power module of claim 17 wherein the switch is a push switch.

19. The power module of claim 13 wherein the stop is an annular flange.

20. A method for lighting a bottle, where the bottle has a sidewall defining an interior of the bottle and a lip of the sidewall defining an opening that is in communication with the interior of the bottle, the method comprising the steps of:
a. providing a device including a power module having a battery, a switch connected to the battery and a bottle stop, the device also having a lighting element including a lamp connected to the switch;
b. inserting the light strand into the interior of the bottle through the opening;
c. inserting the power module into the interior of the bottle through the opening;
d. engaging the sidewall of the bottle with the bottle stop; and
e. activating the switch of the power module so that the lamp of the lighting element is illuminated by the battery.
